(19) United States
(12) Patent Application Publication
(10) Pub. No.: US 2026/0281703 A1
(43) Pub. Date: Sep. 17, 2026

(54) REPORTING METHOD AND APPARATUS THEREFOR

(71) Applicant: BEIJING XIAOMI MOBILE SOFTWARE CO., LTD., Beijing (CN)

(72) Inventor: Yumin WU, Beijing (CN)

(21) Appl. No.: 19/157,288

(22) PCT Filed: Feb. 17, 2023
(86) PCT No.: PCT/CN2023/076980

§ 371 Date: Aug. 15, 2025

(51) Int. Cl. H04W 8/24

(52) U.S. Cl. CPC H04W 8/24

(57) ABSTRACT

A reporting method includes: receiving a reporting indication sent by a network device; and in response to a state of the terminal meeting at least one reporting condition, reporting a carrier aggregation (CA) or dual connectivity (DC) capability change indication to the network device according to the reporting indication.

### CROSS REFERENCE TO RELATED APPLICATIONS

This application is a national phase application based on International Application No. PCT/CN2023/076980, filed on Feb. 17, 2023, the entire content of which is incorporated by reference.

### TECHNICAL FIELD

The disclosure relates to a field of communication technology, in particular to a reporting method and a related apparatus.

### BACKGROUND

For wireless communication, in a case that a wireless transceiver capability of a terminal is shared by a plurality of subscriber identity module (SIM) cards or networks, if one SIM card in the terminal or one network needs to share part of a communication capability occupied by another SIM card or another network, due to lack of interoperability between networks, it cannot obtain a demand of another SIM card or another network on a capability of the terminal, and a network device cannot release its communication capability, which may lead to a decrease of communication efficiency between the terminal and the network, thereby causing a waste of communication resources.

### SUMMARY

According to a first aspect of embodiments of the disclosure, a reporting method is provided. The method is performed by a terminal, and includes:
receiving a reporting indication sent by a network device; and
in response to a state of the terminal meeting at least one reporting condition, reporting a CA or DC capability change indication to the network device according to the reporting indication.

According to a second aspect of embodiments of the disclosure, a reporting method is provided. The method is performed by a network device, and includes:
sending a reporting indication to a terminal; and
receiving a CA or DC capability change indication reported by the terminal, and changing a CA or DC configuration corresponding to the terminal according to the CA or DC capability change indication.

According to a third aspect of embodiments of the disclosure, a communication device is provided. The communication device includes: a processor and a memory having a computer program stored thereon. When the processor is configured to receive a reporting indication sent by a network device; and in response to a state of the terminal meeting at least one reporting condition, report a CA or DC capability change indication to the network device according to the reporting indication.

### BRIEF DESCRIPTION OF THE DRAWINGS

In order to more clearly explain the technical solutions in the embodiments of the disclosure or background technologies, the drawings used in the embodiments of the disclosure or the background technologies will be explained below.

FIG. 1 is a schematic structural diagram of a communication system provided by an embodiment of the disclosure.

FIG. 2 is a flowchart of a reporting method provided by an embodiment of the disclosure.

FIG. 3 is a flowchart of a reporting method provided by an embodiment of the disclosure.

FIG. 4 is a schematic structural diagram of a communication apparatus provided by an embodiment of the disclosure.

FIG. 5 is a schematic structural diagram of a communication device provided by an embodiment of the disclosure.

FIG. 6 is a schematic structural diagram of a chip provided by an embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the attached claims.

The terms used in the embodiments of the disclosure are only for the purpose of describing specific embodiments, and are not intended to limit the embodiments of the disclosure. The singular forms of “a” and “the” used in the embodiments of the disclosure and the attached claims are also intended to include plural forms, unless the context clearly indicates other meanings. It is understandable that the term “and/or” as used herein refers to and includes any or all possible combinations of one or more associated listed items.

It should be understood that depending on the context, the term “if” as used herein may be interpreted as “when”, “while” or “in response to determining”. For the purposes of brevity and ease of understanding, the terms “greater than” or “less than”, “higher than” or “lower than” are used herein to represent size relationships. Those skilled in the art understand that the term “greater than” also covers the meaning of “greater than or equal to”, the term “less than” also covers the meaning of “less than or equal to”, the term “higher than” also covers the meaning of “higher than or equal to”, and the term “lower than” also covers the meaning of “lower than or equal to”.

For ease of understanding, the terms involved in the disclosure are introduced first.

### 1. Multi-SIM (MUSIM)

A terminal may have a plurality of SIM cards installed simultaneously, or a terminal may be registered to a plurality of networks simultaneously. In this case, a wireless transceiver capability of the terminal is shared by the plurality of SIM cards or shared by the plurality of networks.

### 2. DC

A 5G system with a DC structure includes two cell groups:
a master cell group (MCG), corresponding to a master node (MN) on a network side; and
a secondary cell group (SCG), corresponding to a secondary node (SN) on the network side.

The MCG includes one primary cell (PCell) and one or more secondary cells (SCells). The SCG includes one primary secondary cell (PSCell) and one or more SCells. The PCell and the PSCell can be collectively referred to as special cell (SpCell).

### 3. CA

CA is a technology of increasing a transmission bandwidth, which aggregates carries with different frequencies (or the same frequency) into a broader spectrum, and aggregates some discontinuous spectrum fragments together, to increases a bandwidth. For example, a carrier bandwidth of 100 MHz can only have one carrier. In order to pursue a higher transmission rate, the CA technology can be used to connect a plurality of carriers with a user equipment (UE) to provide data transmission. For example, two CA with a bandwidth of 100 MHz are aggregated to obtain a total bandwidth of 200 MHz, and its data transmission rate is twice the rate of the bandwidth of 100 MHz, which improves the usage and the transmission rate.

In order to better understand a reporting method disclosed by the embodiments of the disclosure, a communication system to which the embodiments of the disclosure are applied is introduced first.

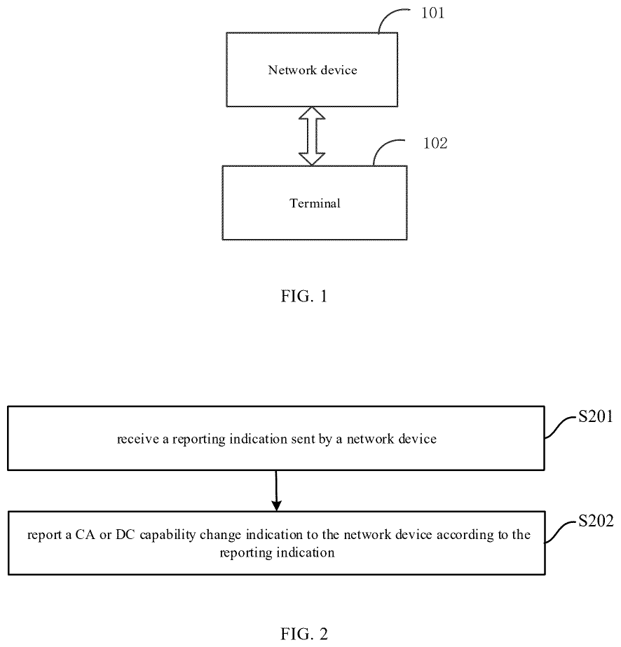

As illustrated in FIG. 1, FIG. 1 is a schematic structural diagram of a communication system provided by an embodiment of the disclosure. The communication system may include, but is not limited to, one network device and one terminal. The number and the form of devices illustrated in FIG. 1 are only for examples and do not constitute as limitations on the embodiments of the disclosure, and two or more network devices and two or more terminals may be included in practical applications. The communication system illustrated in FIG. 1 includes, for example, one network device 101 and one terminal 102.

It should be noted that the technical solution of the embodiments of the disclosure can be applied to various communication systems, such as, a LTE system, a 5G mobile communication system, a 5G NR system, or other future new mobile communication systems. It should also be noted that sidelink in the embodiments of the disclosure may also be referred to as a direct link or a device-to-device link.

The network device 101 in the embodiment of the disclosure is an entity on a network side for transmitting or receiving signals. For example, the network device 101 may be an evolved NodeB (eNB), a transmission reception point (TRP), a next generation NodeB (gNB) in a NR system, a base station in other future mobile communication systems or an access node in a wireless fidelity (Wi-Fi) system. The specific technology and specific device form adopted by the network device are not limited in the embodiments of the disclosure. The network device provided by the embodiment of the disclosure may be composed of a central unit (CU) and a distributed unit (DU). The CU may also be called control unit. The use of CU-DU structure allows to divide a protocol layer of the network device, such as a base station, such that some protocol layer functions are placed in the CU for centralized control, and some or all of the remaining protocol layer functions are distributed in the DU, which is centrally controlled by the CU.

The terminal 102 in the embodiment of the disclosure is an entity on a user side for receiving or transmitting signals, such as a cellular phone. The terminal may also be referred to as terminal, UE, mobile station (MS), mobile terminal (MT), and the like. The terminal may be a car with communication functions, a smart car, a mobile phone, a wearable device, a Pad, a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and specific device form adopted by the terminal are not limited in the embodiments of the disclosure.

During wireless communication, when a wireless transceiver capability of the terminal is shared by a plurality of SIM cards (or, shared by a plurality of networks), if the terminal includes two SIM cards: SIM-A and SIM-B, a CA or DC configuration is configured for the SIM-A in the terminal. In this case, if the SIM-B in the terminal needs to share part of a CA or DC capability occupied by the SIM-A, since the CA or DC configuration is configured by a network-A for the SIM-A in the terminal, the network-A corresponding to the SIM-A cannot know a demand of the SIM-B on the capability of the terminal in a network-B, and thus it cannot release a CA or DC capability of the SIM-A. Therefore, the SIM-B in the terminal cannot obtain a wireless transceiver capability of the terminal it requires, resulting in more packet loss in the SIM-B.

It is understandable that the communication system described in the embodiment of the disclosure is intended to clearly illustrate the technical solution according to the embodiments of the disclosure, and does not constitute as a limitation on the technical solution according to the embodiments of the disclosure. It is understandable by those skilled in the art that as system architectures evolve and new business scenarios emerge, the technical solution provided by the embodiments of the disclosure are also applicable to similar technical problems.

A reporting method and a related apparatus provided by the disclosure will be introduced in detail in combination with the accompanying drawings.

As illustrated in FIG. 2, FIG. 2 is a flowchart of a reporting method provided by an embodiment of the disclosure. The method is performed by a terminal. As illustrated in FIG. 2, the method may include, but is not limited to, the following steps.

At step S201, a reporting indication sent by a network device is received.

In the embodiment, if the terminal has a plurality of SIM cards, these SIM cards share a wireless transceiver capability of the terminal. If a first SIM card (among the plurality of SIM cards) needs to share the wireless transceiver capability occupied by a second SIM card (which is a SIM card different from the first SIM card), since a network corresponding to the second SIM card has already configured a certain communication capability for the second SIM card, the network corresponding to the second SIM card needs to obtain a demand of a network corresponding to the first SIM card on the capability of the terminal, so as to release the demand of the network corresponding to the first SIM card on the capability of the first SIM card, and provide this part of capability to the first SIM card for communication. The network device sends the reporting indication to the terminal to indicate the terminal to report its capability.

At step S202, a CA or DC capability change indication is reported to the network device according to the reporting indication.

In the embodiment, after the terminal receives the reporting indication, it indicates that the network device requires the terminal to report its capability, then the terminal generates a CA or DC capability change indication and sends the CA or DC capability change indication to the network device.

By implementing the embodiment of the disclosure, the CA or DC capability change indication is reported according to the reporting indication sent by the network device and a state of the terminal, so that the network device can change a CA or DC configuration corresponding to the terminal, which is beneficial to improving a communication efficiency, and may avoid waste of communication resources.

In an embodiment of the disclosure, the reporting indication includes at one of:
an indication related to reporting disabling or restoring information of a CA capability;
an indication related to reporting disabling or restoring information of a DC capability;
an indication related to reporting releasing information of a secondary cell (SCell);
an indication related to reporting activating or deactivating information of a SCell;
an indication related to reporting releasing information of a secondary cell group (SCG); or
an indication related to reporting activating or deactivating information of a SCG.

In the embodiment, the reporting indication is used to indicate to the terminal whether it is allowed to report the above-mentioned capability or information.

In a possible embodiment, the reporting indication includes the indication related to reporting the disabling or restoring information of the CA capability, and the indication related to reporting disabling or restoring information of the CA capability may indicate that the terminal is allowed to report an indication to disable or restore the CA capability. The terminal may report the indication to disable the CA capability, or the indication to restore the CA capability, to enable the network device to disable or restore the CA capability.

In a possible embodiment, the reporting indication includes the indication related to reporting the releasing information of the SCell, and the indication related to reporting the releasing information of the SCell indicates that the terminal is not allowed to report the releasing information of the SCell, then the terminal cannot report the releasing information of the SCell to the network device, so that the network device cannot release the SCell.

It is understood that the reporting indication includes any one of: an indication of allowing to report the disabling or restoring information of the CA capability, an indication of allowing to report the disabling or restoring information of the DC capability, an indication of allowing to report the releasing information of the SCell, an indication of allowing to report the activating or deactivating information of the SCell, or an indication of allowing to report the releasing information of the SCG, or an indication of allowing to report the activating or deactivating information of the SCG.

In a possible embodiment, before reporting the CA or DC capability change indication to the network device according to the reporting indication, the method further includes:
determining the at least one reporting condition that the state of the terminal meets.

In the embodiment, the terminal needs to check its state. If the state meets the preset reporting condition, for example, when the terminal is in a multi-card operation mode and has received the reporting indication, the terminal knows that the network device requires the terminal to report its capability, then the terminal generates the CA or DC capability change indication and reports the indication to the network device.

In an embodiment of the disclosure, the reporting condition includes at least one of that:
a temperature of the terminal is greater than a preset temperature threshold;
the terminal is in a multi-card operation mode;
the terminal is in a multi-network operation mode;
the terminal is in a multi-RAT operation mode; or
the terminal is interfered.

In the embodiment, if the temperature of the terminal is greater than the preset temperature threshold, the terminal is in an overheating state.

In the multi-network operation mode, a SIM card in the terminal is registered to a plurality of networks, and the SIM card is capable of communicating with the plurality of registered networks simultaneously.

The RAT is a basic physical connection method applicable to wireless communication networks. In the multi-RAT operation mode, a terminal operates through various RATs simultaneously, such as Bluetooth, Wi-Fi, near field communication (NFC), 3G, 4G, LTE or 5G.

When a terminal is interfered, a signal sent by the terminal interferes with a reception of signal by its receiver, and thus a configuration of an access network of the terminal needs to be changed.

In an embodiment of the disclosure, the CA or DC capability change indication includes at least one of:
an indication to disable or restore the CA capability;
an indication to disable or restore the DC capability;
an indication to release the SCell;
an indication to activate or deactivate the SCell;
an indication to release the SCG; or
an indication to activate or deactivate the SCG.

In the embodiment, when the terminal indicates to “disable CA capability” through the CA or DC capability change indication, the terminal requests the network device not to configure CA (e.g., not to configure SCell). When the terminal indicates to “restore CA capability”, the terminal indicates the network device to configure CA (e.g., configure SCell).

When the terminal indicates to “disable DC capability”, the terminal requests the network device not to configure DC (e.g., not to configure SCG). When the terminal indicates to “restore DC capability”, the terminal informs the network device to configure DC (e.g., configure SCG).

In an embodiment of the disclosure, the indication to release the SCell includes any one of:
an indication to release all SCells;
identification information of a SCell to be released;
identification information of a cell group to be released; or
identification information of a SCell to be released, and identification information of a cell group corresponding to the SCell to be released.

In the embodiment, if the CA or DC capability change indication includes the indication to release SCell, the network device needs to release SCell and perform the carrier aggregation process. After an initial security activation procedure, SCell is released through a radio resource control (RRC) connection reconfiguration message (i.e., RRCConnectionReconfiguration). These released SCells can be used for carrier aggregation, and carriers of different frequencies (or the same frequency) are aggregated into a broader spectrum, which increases a data transmission rate.

If the indication to release the SCell includes the indication to release all SCells, the network device is required to release all SCells.

If the indication to release the SCell includes the identification information of the SCell to be released, the network device is required to release a corresponding SCell according to the identification information of the SCell to be released.

If the indication to release SCell includes the identification information of the cell group to be released, the network device is required to release all SCells in a cell group corresponding to the identification information of the cell group to be released;

If the indication to release SCell includes the identification information of the SCell to be released, and the identification information of the cell group corresponding to the SCell to be released, the network device is required to release a SCell corresponding to the identification information of the SCell to be released in the identification information of the cell group corresponding to the SCell to be released.

In an embodiment of the disclosure, the indication to activate or deactivate the SCell includes any one of:
an indication to activate or deactivate all SCells;
identification information of a SCell to be activated or deactivated;
identification information of a cell group to be activated or deactivated; and
identification information of a SCell to be activated or deactivated, and identification information of a cell group corresponding to the SCell to be activated or deactivated.

In the embodiment, the SCell may be activated or deactivated through a media access control (MAC) control element (CE).

The terminal maintains a SCell deactivation timer for each configured SCell and deactivates the associated SCell when the timer expires.

If the indication to activate or deactivate the SCell includes the indication to activate or deactivate all SCells, the network device is required to activate or deactivate all SCells.

If the indication to activate or deactivate the SCell includes the identification information of the SCell to be activated or deactivated, the network device is required to activate or deactivate a SCell corresponding to the identification information of the SCell to be activated or deactivated.

If the indication to activate or deactivate the SCell includes the identification information of the cell group to be activated or deactivated, the network device is required to activate or deactivate SCells in a cell group corresponding to the identification information of the cell group to be activated or deactivated.

If the indication to activate or deactivate the SCell includes the identification information of the SCell to be activated or deactivated, and the identification information of the cell group corresponding to the SCell to be activated or deactivated, the network device is required to activate or deactivate a SCell corresponding to the identification information of the SCell to be activated or deactivated in a cell group corresponding to the identification information of the cell group corresponding to the SCell to be activated or deactivated.

In a possible embodiment, in the CA or DC capability change indication, when the terminal indicates to “deactivate SCell”, the terminal requests the network device to deactivate a configured SCell. When the terminal indicates to “activate SCell”, the terminal requests the network device to activate the configured SCell.

In a possible embodiment, when the terminal indicates to “deactivate SCell”, the terminal requests the network device to deactivate a configured SCell. When the terminal indicates to “activate SCell”, the terminal requests the network device to activate the configured SCell.

In a possible embodiment, the CA or DC capability change indication includes the indication to activate or deactivate the SCell. When the terminal indicates to “deactivate SCG”, it indicates the terminal requests the network device to deactivate a configured SCG. When the terminal indicates to “activate SCG”, the terminal requests the network device to activate the configured SCG.

In an embodiment of the disclosure, the method further includes:
indicating frequency information corresponding to the CA or DC capability change indication, in which the frequency information includes at least one of:
frequency band combination information; or
frequency band information.

In the embodiment, since the SCell can be configured on different frequency bands, to support the terminal to perform wireless communications on different frequency bands. Frequency band refers to a frequency range of electromagnetic waves, which is represented by a frequency width occupied by signal. When the terminal needs to communicate with the network device on a specific frequency band or a specific combination of frequency band, it sends the frequency information to the network device, so that the network device can configure the SCell within a frequency range corresponding to the frequency band or the combination of frequency band, which improves a communication efficiency.

In an embodiment of the disclosure, the method further includes:
reporting the at least one reporting condition that the state of the terminal meets to the network device.

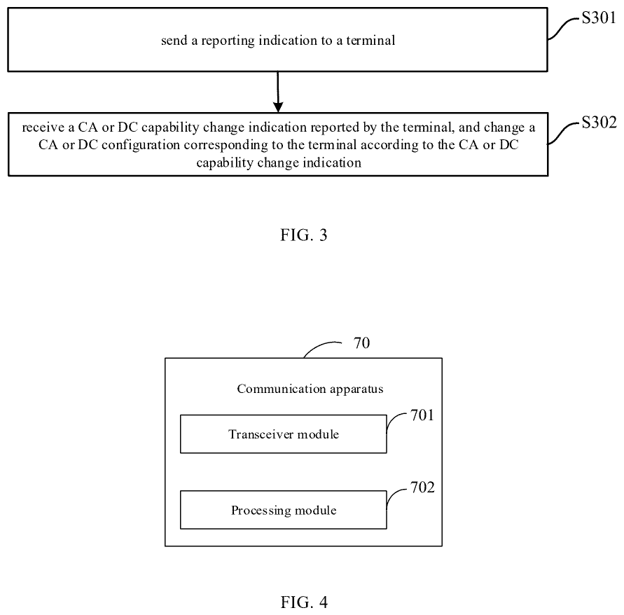

As illustrated in FIG. 3, FIG. 3 is a flowchart of a reporting method provided by an embodiment of the disclosure. The method is performed by a network device. As illustrated in FIG. 3, the method may include, but is not limited to, the following steps.

At step S301, a reporting indication is sent to a terminal.

In the embodiment, if the terminal has a plurality of SIM cards, these SIM cards share a wireless transceiver capability of the terminal. If a first SIM card (among the plurality of SIM cards) needs to share the wireless transceiver capability occupied by a second SIM card (which is a SIM card different from the first SIM card), the network device needs to obtain a demand of the first SIM card in a corresponding network on the capability of the terminal. The network device sends the reporting indication to the terminal to indicate the terminal to report its capability.

At step S302, a CA or DC capability change indication reported by the terminal is received, a CA or DC configuration corresponding to the terminal is changed according to the CA or DC capability change indication.

In the embodiment, the terminal needs to check its current state. If the state meets the preset reporting condition, for example, when the terminal is in a multi-card operation mode and has received the reporting indication, the terminal knows that it is required to report its capability to the network device, then it generates the CA or DC capability change indication and reports the indication to the network device. The network device changes the CA or DC configuration corresponding to the terminal according to the CA or DC capability change indication.

By implementing the embodiment of the disclosure, the CA or DC capability change indication is reported according to the reporting indication sent by the network device and the state of the terminal, so that the network device can change the CA or DC configuration corresponding to the terminal, which is beneficial to improving a communication efficiency and may avoid a waste of communication resources.

In an embodiment of the disclosure, the reporting indication includes at one of:
an indication related to reporting disabling or restoring information of a CA capability;
an indication related to reporting disabling or restoring information of a DC capability;
an indication related to reporting releasing information of a secondary cell (SCell);
an indication related to reporting activating or deactivating information of a SCell;
an indication related to reporting releasing information of a secondary cell group (SCG); or
an indication related to reporting activating or deactivating information of a SCG.

In an embodiment of the disclosure, the CA or DC capability change indication includes at least one of:
an indication to disable or restore the CA capability;
an indication to disable or restore the DC capability;
an indication to release the SCell;
an indication to activate or deactivate the SCell;
an indication to release the SCG; or
an indication to activate or deactivate the SCG.

In an embodiment of the disclosure, the indication to release the SCell includes any one of:
an indication to release all SCells;
identification information of a SCell to be released;
identification information of a cell group to be released; or
identification information of a SCell to be released, and identification information of a cell group corresponding to the SCell to be released.

In an embodiment of the disclosure, the indication to activate or deactivate SCell includes any one of:
an indication to activate or deactivate all SCells;
identification information of a SCell to be activated or deactivated;
identification information of a cell group to be activated or deactivated; or
identification information of a SCell to be activated or deactivated, and identification information of a cell group corresponding to the SCell to be activated or deactivated.

In an embodiment of the disclosure, the method further includes:
receiving frequency information corresponding to the CA or DC capability change indication sent by the terminal, in which the frequency information includes at least one of:
frequency band combination information; or
frequency band information.

In an embodiment of the disclosure, the method further includes:
reporting at least one reporting condition that a state of the terminal meets to the network device, in which the reporting condition includes at least one of that:
a temperature of the terminal is greater than a preset temperature threshold;
the terminal is in a multi-card operation mode;
the terminal is in a multi-network operation mode;
the terminal is in a multi-RAT operation mode; or
the terminal is interfered.

In the above embodiments provided by the disclosure, the methods provided by the embodiments of the disclosure are introduced from the perspectives of the network device and the terminal, respectively. In order to implement the functions in the methods provided by the embodiments of the disclosure, the network device and the terminal may include a hardware structure and a software module, and the above functions are implemented in the form of the hardware structure, the software module, or a combination of the hardware structure and the software module. One of the above functions may be implemented in the hardware structure, the software module, or a combination of the hardware structure and the software module.

As illustrated in FIG. 4, FIG. 4 is a schematic structural diagram of a communication apparatus 70 provided by an embodiment of the disclosure. The communication apparatus 70 shown in FIG. 4 includes: a transceiver module 701 and a processing module 702. The transceiver module 701 includes: a sending module and/or a receiving module. The sending module is configured to implement a sending function, and the receiving module is configured to implement a receiving function. The transceiver module 701 may implement the sending function and/or the receiving function.

The communication apparatus 70 may be a terminal (e.g., the terminal in the above method embodiments), a device in the terminal, or a device that can be used together with the terminal. Or, the communication apparatus 70 may be a network device, a device in the network device, or a device that can be used together with the network device.

In a case that the communication apparatus 70 is a terminal (e.g., the terminal in the above method embodiments), the apparatus includes:
a transceiver module, configured to receive a reporting indication sent by a network device; and
a processing module, configured to, in response to a state of the terminal meeting at least one reporting condition, report a CA or DC capability change indication to the network device according to the reporting indication.

In a case that the communication apparatus 70 is a network device, the apparatus includes:
a transceiver module, configured to send a reporting indication to a terminal; and
a processing module, configured to, receive a CA or DC capability change indication reported by the terminal, and change a CA or DC configuration corresponding to the terminal according to the CA or DC capability change indication.

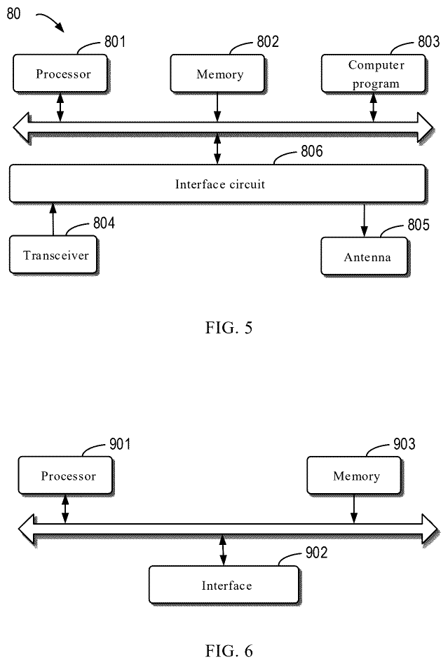

FIG. 5 is a schematic structural diagram of a communication device 80 provided by an embodiment of the disclosure. The communication device 80 may be a network device, a terminal (e.g., the terminal in the above method embodiments), or a chip, a chip system or a processor that supports the network device to implement the above-described method, or a chip, a chip system or a processor that supports the terminal to implement the above-described method. The device may be used to implement the methods described in the above method embodiments with reference to the description of the above-described method embodiments.

The communication device 80 may include one or more processors 801. The processor 801 may be a general purpose processor or a dedicated processor, such as, a baseband processor or a central processor. The baseband processor is used for processing communication protocols and communication data. The central processor is used for controlling the communication device (e.g., base station, baseband chip, terminal, terminal chip, DU, or CU), executing computer programs, and processing data of the computer programs.

In an embodiment of the disclosure, the communication device 80 may include one or more memories 802 on which a computer program 803 may be stored. The processor 801 executes the computer program 803 to cause the communication device 80 to perform the methods described in the above method embodiments. In an embodiment of the disclosure, the memory 802 may also store data. The communication device 80 and the memory 802 may be provided separately or may be integrated together.

In an embodiment of the disclosure, the communication device 80 may also include a transceiver 804 and an antenna 805. The transceiver 804 may be referred to as transceiver unit, transceiver machine, or transceiver circuit, for realizing a transceiver function. The transceiver 804 may include a receiver and a transmitter. The receiver may be referred to as receiver machine or receiving circuit, for realizing a receiving function. The transmitter may be referred to as transmitter machine or transmitting circuit, for realizing a transmitting function.

In an embodiment of the disclosure, the communication device 80 may also include one or more interface circuits 806. The interface circuits 806 are used to receive code instructions and transmit the code instructions to the processor 801. The processor 801 runs the code instructions to cause the communication device 80 to perform the methods described in the above method embodiments.

In a case that the communication device 80 is a terminal (e.g., the terminal in the above method embodiments), the processor 801 is used to execute steps S201 and S202 in FIG. 2.

In a case that the communication device 80 is a network device, the transceiver 804 is used to execute steps S301 and S302 in FIG. 3.

In an implementation, the processor 801 may include a transceiver for implementing the receiving and transmitting functions. The transceiver may be, for example, a transceiver circuit, an interface or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 801 may store a computer program 803 that can be executed by the processor 801. When the processor 801 executes the computer program 803, the communication device 80 is caused to implement the methods described in the method embodiments above. The computer program 803 may be solidified in the processor 801, in which case the processor 801 may be implemented by hardware.

In an implementation, the communication device 80 may include circuits. The circuits may implement the sending, receiving or communicating function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs) and electronic devices. The processor and the transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above embodiments may be a network device or a terminal (e.g., the terminal in the above method embodiments), but the scope of the communication device described in the disclosure is not limited thereto, and the structure of the communication device is not limited by FIG. 5. The communication device may be a stand-alone device or may be part of a larger device. For example, the communication device may be:
(1) a stand-alone IC, chip, chip system or subsystem;
(2) a collection of ICs including one or more ICs, in an embodiment of the disclosure, the collection of ICs may also include storage components for storing data and computer programs;
(3) an ASIC, such as a modem;
(4) modules that can be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

The case that the communication device is a chip or a chip system can refer to the schematic structural diagram of a chip in FIG. 6. In FIG. 6, the chip includes a processor 901 and an interface 902. There may be one or more processors 901, and there may be multiple interfaces 902.

In an embodiment of the disclosure, the chip may also include a memory 903 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described functions, but such implementations should not be construed as being beyond the scope of protection of the embodiments of the disclosure.

The embodiment of the disclosure also provides a reporting system. The system includes a communication device as a terminal (e.g., the terminal in the above method embodiments) and a communication device as a network device in the embodiment of FIG. 4, or the system includes a communication device as a terminal (e.g., the terminal in the above method embodiments) and a communication device as a network device in the embodiment of FIG. 5.

The disclosure also provides a readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs)) or wirelessly (e.g., by using infrared wave, wireless wave, or microwave). The computer-readable storage medium may be any usable medium to which the computer has access or a data storage device integrated by one or more usable mediums, e.g., a server or a data center. The usable medium may be a magnetic medium (e.g., floppy disk, hard disk and tape), an optical medium (e.g., a high-density digital video disc (DVD)), or a semiconductor medium (e.g., a solid state disk (SSD)).

Those skilled in the art understand that “first”, “second” and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four or more, which is not limited in the disclosure. In the embodiments of the disclosure, for a type of technical features, “first”, “second” and “third”, and “A”, “B”, “C” and “D” are used to distinguish different technical features of the type, the technical features described using the “first”, “second” and “third”, and “A”, “B”, “C” and “D” do not indicate any order of precedence or magnitude.

The correspondences shown in the tables in the disclosure may be configured or predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in the disclosure may not be configured. For another example, the above tables may be adjusted appropriately, such as splitting, combining, and the like. The names of the parameters shown in the titles of the above tables may be other names that can be understood by the communication device, and the values or representations of the parameters may be other values or representations that can be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in the disclosure may be understood as define, predefine, store, pre-store, pre-negotiate, pre-configure, solidify, or pre-fire.

Those skilled in the art may realize that the units and algorithmic steps of various examples described in combination with the embodiments disclosed herein are capable of being implemented in the form of electronic hardware, or a combination of computer software and electronic hardware. Whether these functions are implemented in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can refer to the corresponding processes in the preceding method embodiments, which will not be repeated herein.

The above are only specific implementations of the disclosure, but the scope of protection of the disclosure is not limited thereto. Those skilled in the art familiar to the technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A reporting method, performed by a terminal, comprising:
receiving a reporting indication sent by a network device; and
in response to a state of the terminal meeting at least one reporting condition, reporting a carrier aggregation (CA) or dual connectivity (DC) capability change indication to the network device according to the reporting indication.

2. The method of claim 1, wherein the reporting indication comprises one or more of:
an indication related to reporting disabling or restoring information of a CA capability;
an indication related to reporting disabling or restoring information of a DC capability;
an indication related to reporting releasing information of a secondary cell (SCell);
an indication related to reporting activating or deactivating information of a SCell;
an indication related to reporting releasing information of a secondary cell group (SCG); or
an indication related to reporting activating or deactivating information of a SCG.

3. The method of claim 1, wherein before reporting the CA or DC capability change indication to the network device according to the reporting indication, the method further comprises:
determining the at least one reporting condition that the state of the terminal meets.

4. The method of claim 3, wherein the reporting condition comprises at least one of:
a temperature of the terminal is greater than a preset temperature threshold;
the terminal is in a multi-card operation mode;
the terminal is in a multi-network operation mode;
the terminal is in a multi-radio access technology (RAT) operation mode; or
the terminal is interfered.

5. The method of claim 1, wherein the CA or DC capability change indication comprises at least one of:
an indication to disable or restore a CA capability;
an indication to disable or restore a DC capability;
an indication to release a SCell;
an indication to activate or deactivate a SCell;
an indication to release a SCG; or
an indication to activate or deactivate a SCG.

6. The method of claim 5, wherein the indication to release the SCell comprises one or more of:
an indication to release all SCells;
identification information of a SCell to be released;
identification information of a cell group to be released; or
identification information of a SCell to be released, and identification information of a cell group corresponding to the SCell to be released.

7. The method of claim 5, wherein the indication to activate or deactivate the SCell comprises one or more of:
an indication to activate or deactivate all SCells;
identification information of a SCell to be activated or deactivated;
identification information of a cell group to be activated or deactivated; or
identification information of a SCell to be activated or deactivated, and identification information of a cell group corresponding to the SCell to be activated or deactivated.

8. The method of claim 1, further comprising:
indicating frequency information corresponding to the CA or DC capability change indication, wherein the frequency information comprises at least one of:
frequency band combination information; or
frequency band information.

9. The method of claim 1, further comprising:
reporting the at least one reporting condition that the state of the terminal meets to the network device.

10. A reporting method, performed by a network device, comprising:
sending a reporting indication to a terminal; and
receiving a carrier aggregation (CA) or dual connectivity (DC) capability change indication reported by the terminal, and changing a CA or DC configuration corresponding to the terminal according to the CA or DC capability change indication.

11. The method of claim 9, wherein the reporting indication comprises one or more of:
an indication related to reporting disabling or restoring information of a CA capability;
an indication related to reporting disabling or restoring information of a DC capability;
an indication related to reporting releasing information of a secondary cell (SCell);
an indication related to reporting activating or deactivating information of a SCell;
an indication related to reporting releasing information of a secondary cell group (SCG); or
an indication related to reporting activating or deactivating information of a SCG.

12. The method of claim 10, wherein the CA or DC capability change indication comprises one or more of:
an indication to disable or restore a CA capability;
an indication to disable or restore a DC capability;
an indication to release a SCell;
an indication to activate or deactivate a SCell;
an indication to release a SCG; or
an indication to activate or deactivate a SCG.

13. The method of claim 12, wherein the indication to release the SCell comprises one or more of:
an indication to release all SCells;
identification information of a SCell to be released;
identification information of a cell group to be released; or
identification information of a SCell to be released, and identification information of a cell group corresponding to the SCell to be released.

14. The method of claim 12, wherein the indication to activate or deactivate the SCell comprises one or more of:
an indication to activate or deactivate all SCells;
identification information of a SCell to be activated or deactivated;
identification information of a cell group to be activated or deactivated; or
identification information of a SCell to be activated or deactivated, and identification information of a cell group corresponding to the SCell to be activated or deactivated.

15. The method of claim 10, further comprising:
receiving frequency information corresponding to the CA or DC capability change indication sent by the terminal, wherein the frequency information comprises at least one of:
frequency band combination information; or
frequency band information.

16. The method of claim 10, further comprising:
receiving at least one reporting condition that a state of the terminal meets reported by the terminal, wherein the reporting condition comprises at least one of:
a temperature of the terminal is greater than a preset temperature threshold;
the terminal is in a multi-card operation mode;
the terminal is in a multi-network operation mode;
the terminal is in a multi-radio access technology (RAT) operation mode; or
the terminal is interfered.

17-18. (canceled)

19. A communication device, comprising a processor and a memory, wherein the memory stores a computer program, and the processor, in response to execution of the computer program, is configured to:
receive a reporting indication sent by a network device; and
in response to a state of the terminal meeting at least one reporting condition, report a carrier aggregation (CA) or dual connectivity (DC) capability change indication to the network device according to the reporting indication.

20. (canceled)

21. A non-transitory computer-readable storage medium, wherein the storage medium is configured to store instructions, and when the instructions are executed, the method according to claim 1 is implemented.

22. A communication device, comprising a processor and a memory, wherein the memory stores a computer program, and the processor, in response to execution of the computer program, is configured to the method according to claim 10.

23. A non-transitory computer-readable storage medium, wherein the storage medium is configured to store instructions, and when the instructions are executed, the method according to claim 10 is implemented.
